(19) United States
(12) Patent Application Publication
(10) Pub. No.: US 2023/0221104 A1
(43) Pub. Date: Jul. 13, 2023

(54) A sensor module for detecting unevenness of a surface, an apparatus comprising the same and a method for detecting unevenness of a surface using the said sensor module

(71) Applicant: RAYONG ENGINEERING AND PLANT SERVICE CO., LTD., Bangsue, Bangkok (TH)

(72) Inventors: Paisal PANDUM, Samut Sakhon (TH); Santipap UMPAWANWONG, Nakhonsawan (TH); Varith PUNTURAUMPORN, Bangkok (TH); Komgrit SATIRAPATTANAKUL, Chaiyaphum (TH); Deacha KANPUKDEE, Samutsakhon (TH); Kittikun CHONGCHAROEN, Rayong (TH); Thanon SONGDECHPHEERAKORN, Rayong (TH)

(73) Assignee: RAYONG ENGINEERING AND PLANT SERVICE CO., LTD., Bangsue, Bangkok (TH)

(21) Appl. No.: 18/011,058

(22) PCT Filed: Jun. 18, 2021
(86) PCT No.: PCT/IB2021/055383

§ 371 Date: Dec. 16, 2022

(30) Foreign Application Priority Data
Jun. 18, 2020 (SG) 10202005824X

(51) Int. Cl. G01B 7/16; G01B 7/016; B25J 9/10; B25J 9/16; G01B 7/06; B25J 15/06

(52) U.S. Cl. CPC G01B 7/16; G01B 7/016; B25J 9/1005; B25J 9/1602; G01B 7/06; B25J 15/0608

(57) ABSTRACT

The present invention relates to a sensor module for detecting unevenness of a surface, especially for detecting bulging and bowing of the pipe external surface. The sensor module comprises an arm assembly comprising an arm body having at least two ends, one or more surface contacting element mounted to at least one end of the arm body; a magnet assembly comprising at least one magnet to generate magnetic lines of force; and a magnetic sensor assembly comprising a magnetic sensor being assembled adjacent to the magnet for sensing changes in the magnetic lines of force in response to movement of the arm body. The invention also relates to an apparatus comprising the said sensor module and a method for detecting unevenness of a surface using the said sensor module.

### FIELD OF THE INVENTION

The present invention relates to a sensor module for detecting unevenness of a surface. The invention also relates to an apparatus comprising the said sensor module and a method for detecting unevenness of a surface using the said sensor module.

### BACKGROUND OF THE INVENTION

The operation in industrial plants requires various equipment, such as pipes, coils, tanks, reactors, boilers, etc. In some circumstances, those equipment are operated under severe conditions, for example, under a corrosive environment, high pressure or high temperature. Such severe conditions can lead to the deformation of the material such that the equipment may become deformed, bulged out and cracked. The said defects in many cases can be detected by inspecting the surface of the equipment and if the surface found deform or uneven, it is required to investigate the problem occurs and allow maintenance in time.

Accordingly, there is a need to develop an apparatus or method that can effectively determine the unevenness of the surface or deformation of the equipment. Examples of the relevant arts are as follows.

The European patent no. 0 297 541 B1 discloses an automatic tube circumference scanning apparatus for automatically performing inspections, repairs and other works for a group of tubes arrayed in a narrow space as directed in the horizontal directions. The apparatus is composed of an upper support/traverse section mounted on an upper tube in the group of tubes so as to be able to travel along a tube axis and to stop and grip said upper tube, a lower support/traverse section mounted on a lower tube so as to be able to travel, stop and grip said lower tube, a flexible rail extended vertically between the upper and lower support/traverse sections and fixed thereto, and a probe scanning section mounted on the flexible rail so as to be able to move up and down, which grips any arbitrary tube between the aforementioned upper and lower tubes for making a probe scan around the same tube.

However, the apparatus according to the said European patent can be applied to horizontal operation only. It is not suitable for vertical operation.

The Japanese patent no. 4775492 B2 discloses a surface inspection apparatus and a method for optically detecting a fine uneven flaw such as a thin steel sheet. The apparatus includes a light source for irradiating the surface of a steel plate with light at a wavelength of 10.6 μm or longer and a detecting system for detecting minute defects in accordance with a light-dark pattern obtained by focusing and diffusion of light reflected by minute irregular flaws with irregularities on the surface of the steel plate. The light source irradiates, with light, those portions of the steel plate which is in contact with rolls. The detection system includes a screen onto which the light reflected by the surface of the steel plate is projected and a two-dimensional camera for measuring a light intensity distribution on the screen.

The technique of this Japanese patent requires an angle of incidence as large as close to 90°, thereby making it difficult to introduce a necessary apparatus into an actual operation line. It has also the problem that adjustment of optics is difficult.

There are also developments of the detection of the defect or unevenness of a surface wherein magnetic flux detection/sensing technologies are applied, as disclosed in the following publications,

The Japanese patent publication no. H08-160006 discloses a technique for detecting an inclusion existing inside an object using a magnetic flux leakage inspection method. The surface defects can be detected by using the magnetic flux leakage inspection method in the form of leakage flux signals generated by changes in the surface shape.

The US patent publication no. 2011/0000338 A1 discloses a method and apparatus for detecting a concavo-convex shape surface defect existing on a ferromagnetic metal object including sensing a signal attributed to the strain of the concavo-convex shape surface defect. The signal is magnetic flux leaking from the ferromagnetic metal to which magnetic flux is applied. The detecting apparatus incorporates a magnetizer for magnetizing a ferromagnetic metal and a plurality of magnetic sensors arranged in the direction perpendicular to a traveling direction of the ferromagnetic metal to sense a signal attributed to the strain of a concavo-convex shape surface defect.

The method and apparatus according to the above-mentioned US publication are limited to the surface defect having a size in a range of 0.5 to 6 μm. Thus, it cannot be used in a variety of applications.

### SUMMARY OF THE INVENTION

The present invention, therefore, aims to constitute a sensor module for detecting unevenness of a surface, especially bulging and bowing of the surface, that seeks to overcome the problems of the prior arts discussed above, while at the same time providing an effective, simple easily constructed module that is readily adapted to a variety of applications.

One aspect of the present invention relates to a sensor module for detecting unevenness of a surface, the sensor module comprising an arm assembly comprising an arm body having at least two ends, one or more surface contacting element mounted to at least one end of the arm body; a magnet assembly comprising at least one magnet to generate magnetic lines of force; and a magnetic sensor assembly comprising a magnetic sensor being assembled adjacent to the magnet for sensing changes in the magnetic lines of force in response to movement of the arm body.

Another aspect of the present invention is to provide an apparatus for detecting unevenness of a surface that comprises the sensor module constituting the advantages as mentioned above which is assembled to a driving tool for driving the sensor module along the surface to be detected.

Yet, another aspect of the present invention is to provide a method for detecting unevenness of a surface, the method comprising steps of:
a) inspecting the surface by using the sensor module according to the present invention to obtain data of changes in the magnetic lines of force;
b) sending data obtained from a) to the processor; and
c) converting data received from b) to distance changed from an initial position to a detected position to determining unevenness profiles of the surface.

The sensor module, apparatus comprising the sensor module and method using the sensor module according to the present invention allows detection of the unevenness of the surface of equipment installed in a narrow space. Moreover, it can be operated in multi-direction, for example, the horizontal, incline or vertical directions.

### BRIEF DESCRIPTION OF DRAWINGS

FIG. 1 is a side view of the sensor module according to the first exemplary embodiment of the present invention.

FIG. 2 is a top view of the sensor module according to the first exemplary embodiment of the present invention.

FIG. 3 is a side view of the sensor module according to the first exemplary embodiment of the present invention, while contacted to the surface.

FIG. 4 is a side view of the sensor module according to the second exemplary embodiment of the present invention.

FIG. 5 is another side view of the sensor module according to the second exemplary embodiment of the present invention.

FIG. 6 is a front view of the sensor module according to the second exemplary embodiment of the present invention.

FIGS. 7a and 7b is a side view of the sensor module according to the second exemplary embodiment of the present invention, in a normal and detecting position, respectively.

FIG. 8 is a top view of the apparatus for detecting unevenness of the surface according to the first exemplary embodiment of the present invention.

FIG. 9 is a top view of the apparatus for detecting unevenness of the surface according to the second exemplary embodiment of the present invention.

### DETAILED DESCRIPTION OF THE INVENTION

The present invention will now be described by the following details with reference to the accompanying figures.

Use of singular nouns or pronouns when used with “comprising” in claims and description means “one” and will also include “one or more”, “at least one”, and “one or more than one”.

The terms “comprise”, “has/have” and “include” are open-ended verbs, wherein one or more of these verb formats, for example “comprise”, “comprising”, “has/have”, “having”, “include”, “including” are also open-ended verbs. For example, any method that “comprises”, “has” or “includes” one step or more does not limit to one step or steps but also covers the steps that has not been indicated.

Any instrument, equipment or method mentioned herein, unless indicated otherwise, shall mean instrument, equipment or that are generally used or practiced by a person skilled in the art of this field.

The module, apparatus and method disclosed and claimed in this application are intended to cover aspects of the invention obtained from performing, operating, modifying, changing any factors without experimentations that are significantly different from this invention, and acquire the same which have properties, utilities, advantages and results similar to the aspects of the present invention according to those ordinary skilled in the art even without being indicated in claims specifically. Therefore, the substitution for or similarity to the aspects of the present invention including minor modification or change that can be apparent to a person skilled in the art in this field shall be considered under the intention, concept and scope of this invention as appeared in the appended claims.

The first aspect of the present invention relates to a sensor module for detecting unevenness of the surface (S). The sensor module comprises an arm assembly (1) comprising an arm body (1.1) having at least two ends, one or more surface contacting element (1.2) mounted to at least one end of the arm body (1.1); a magnet assembly (2) comprising at least one magnet (2.1) to generate magnetic lines of force; and a magnetic sensor assembly (3) comprising a magnetic sensor (3.1) being assembled adjacent to the magnet (2.1) for sensing changes in the magnetic lines of force in response to movement of the arm body (1.1).

According to the above aspect, the movement of the magnet (2.1) relative to the magnetic sensor (3.1) allows sensing changes in the magnetic lines of force. The changes in the magnetic lines will be then converted into a distance perpendicular to the surface (S).

The arm assembly (1) further comprises a direction controlling means (1.3) for controlling a moving direction of the arm body (1.1) toward-backward the surface (S). The direction controlling means (1.3) is provided for controlling the movement of the arm body (1.1) to be in a desired direction.

In an exemplary embodiment, the arm body (1.1) may be shaped as a bar having an end (1.1.1) and a free end (1.1.2). The shape of the arm body (1.1) is not limited to the bar, other shapes such as cylindrical or triangle shapes are also applicable.

The free end (1.1.2) is configured for mounting to the surface contacting element (1.2) which is biased into contact with the surface (S). The said surface contacting element (1.2) can be any component that facilitates the movement of the sensor module along the surface (S). For example, the contacting element (1.2) may be one or more of a wheel, roller, ball, track, and caterpillar.

According to the above embodiment, the surface contacting element (1.2) is biased into contact with the surface (S) such that the sensor module can effectively sense the changes in the magnetic lines of force relative to the movement of the arm body (1.1).

In a preferred embodiment, the magnet assembly (2) is assembled to the arm assembly (1) in a manner that an arrangement of magnetic lines of force generated from the magnet (2.1) is correlated with the moving direction of the arm body (1.1).

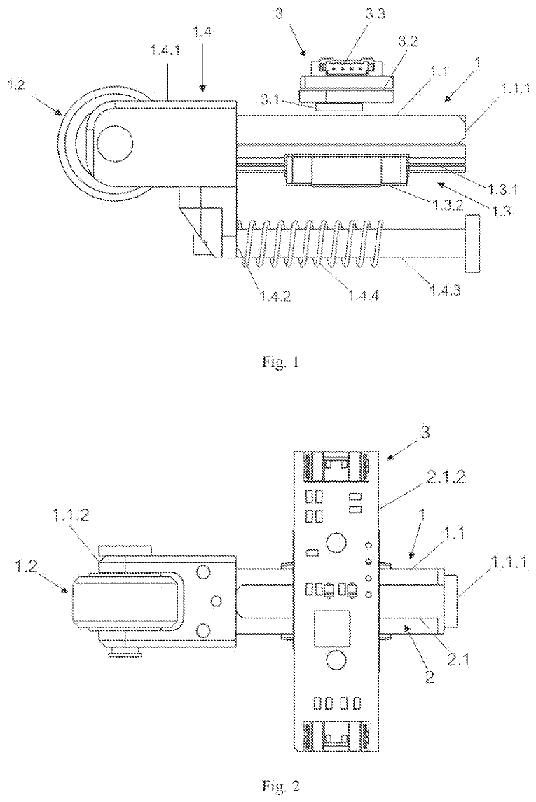

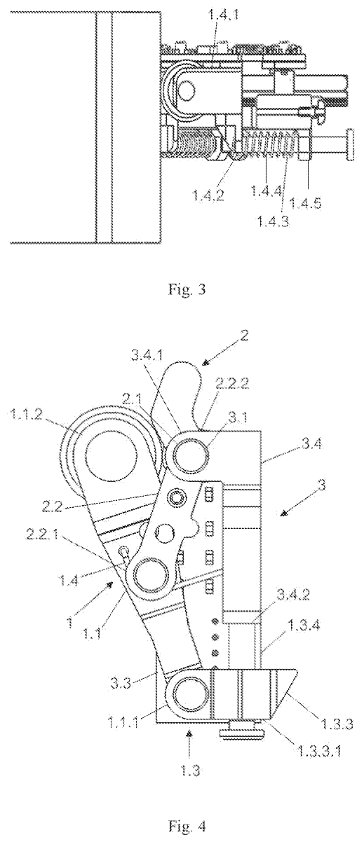

According to the first exemplary embodiment as shown in FIG. 1-3, the direction controlling means (1.3) comprises a moving guide (1.3.1) assembled to the arm body (1.1), and a fixing guide (1.3.2) assembled to the arm body (1.1), wherein the moving guide (1.3.1) and the fixing guide (1.3.2) cooperate to guide the arm body (1.1) moves toward-backward the surface (S) in a direction perpendicular to the surface (S). The direction controlling means (1.3) may comprises other components in addition to the moving guide (1.3.1) and the fixing guide (1.3.2). For example, the direction controlling means (1.3) may comprises a plurality of loops and a guiding rod.

In an embodiment of the present invention, the arm assembly (1) further comprises a biasing assembly (1.4).

According to the first exemplary embodiment as shown in FIG. 1-3, the biasing assembly (1.4) comprises a surface contacting element support (1.4.1), an extended portion (1.4.2) extending downwardly from the surface contacting element support (1.4.1). Further, the biasing assembly (1.4) can comprise an axis (1.4.3) extending from the extended portion (1.4.2) in a direction parallel to the arm body (1.1), a spring (1.4.4) provided on the axis (1.4.3) and an abut portion (1.4.5) provided at an end of the spring (1.4.4) for abutting the spring (1.4.4) in a compressed manner. All described components are arranged to enable the biasing force of the spring (1.4.4) to be transferred to the surface contacting element (1.2) in order to ensure that the surface contacting element (1.2) always contacts the surface (S).

The magnet (2.1) can be selected from any one of magnet strip, magnet bar, round shaped magnet piece, semicircle shaped magnet piece, oval shaped magnet piece, square shaped magnet piece and triangle shaped magnet piece.

According to the first embodiment, the magnet (2.1) may be a magnet strip provided on a surface of the arm body (1.1). Preferably, the magnet strip has a shape that corresponds to a shape of the arm body (1.1). Alternatively, the magnet (2.1) may be a round shaped magnet piece provided in the magnet assembly (2).

According to a preferred embodiment, the sensor module further comprises a processor (4) being in communication with the magnetic sensor assembly (3) for receiving sensing data from the magnetic sensor (3.1) and converting to unevenness profiles of the surface (S). The processor (4) allows the operator to obtain the needed information by converting the data of changes in the magnetic lines of force into unevenness of the surface (S).

According to the first embodiment of the present invention, as clearly shown in FIG. 1, the magnetic sensor assembly (3) comprises the magnetic sensor (3.1); a magnetic sensor holder (3.2) provided for holding the magnetic sensor (3.1) to be in proximity and face the magnet (2.1); and a circuit (3.3) electrically connected to the magnet sensor (3.1) for receiving the sensed data from the magnetic sensor (3.1) and sending the sensed data to the processor (4).

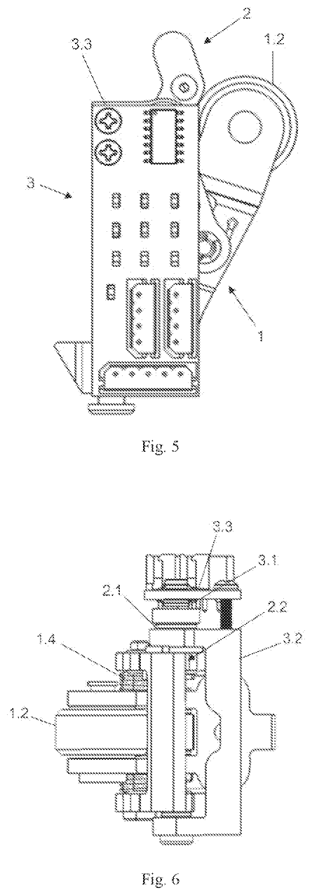

The second exemplary embodiment of the sensor module of this invention is as shown in FIG. 4-7.

According to the second embodiment and FIG. 4, the arm body (1.1) is rotatably assembled to the magnet assembly (2); and the direction controlling means (1.3) comprises a rotating guide (1.3.3) and a fixing rod (1.3.4), the rotating guide (1.3.3) rotatably assembled to the end (1.1.1) of the arm body (1.1) and slidably assembled to the fixing rod (1.3.4) through a hole (1.3.3.1) provided on the rotating guide (1.3.3), and an end of the fixing rod (1.3.4) is assembled to the magnetic sensor assembly (3). The arrangement according to the above second embodiment allows the magnet assembly (2) to rotate in response to the movement of the arm body (1.1). This provides the sensor module with the compact size such that using the sensor module for detecting the surface in narrow space is possible.

According to an alternative embodiment of this invention, the surface contacting element (1.2) is biased into contact with the surface (S) by means of a torsion spring provided between the arm body (1.1) and the magnetic sensor assembly (3).

Referring now to FIG. 4 showing the second exemplary embodiment of the invention, the magnet assembly (2) comprises the magnet (2.1) and a rod (2.2) having an end (2.2.1) rotatably assembled to the arm body (1.1) and another end (2.2.2) rotatably assembled to the magnetic sensor assembly (3). Preferably, the magnet (2.1) is a magnet rotary which is provided at a position where the rod (2.2) is assembled to the magnetic sensor assembly (3).

As shown in FIG. 4-6, the magnetic sensor assembly (3) according to the second embodiment comprises a magnetic sensor frame (3.4) to which the magnetic sensor (3.1) is attached, and the circuit (3.3) mounted to the magnetic sensor frame (3.4) and electrically connected to the magnet sensor (3.1) for receiving the sensed data from the magnetic sensor (3.1) and sending the sensed data to the processor (4).

In a preferred embodiment, the magnetic sensor frame (3.4) is in L-inverted shape having an end (3.4.1) rotatably assembled to the magnet assembly (2) and another end (3.4.2) assembled to the fixing rod (1.3.4) of the direction controlling means (1.3). And, the magnetic sensor (3.1) is attached on the magnetic sensor frame (3.4) at a position proximity to the magnet (2.1) to sense the rotation of the magnet (2.1).

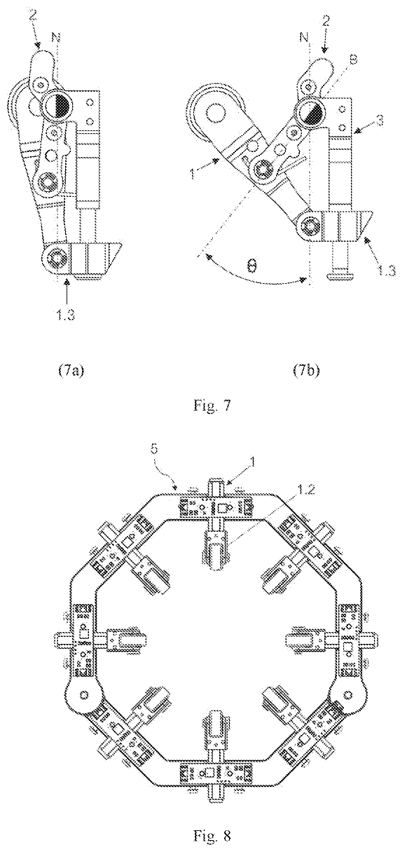

FIG. 7a shows the sensor module according to the second exemplary embodiment of this invention, that is in a normal position (N). FIG. 7b shows the sensor module that is in a detecting position (B), where the rod (2.2) equipped with the magnet (2.1) moves from the normal position (N) to the detecting position (B) as an angle (0).

The second aspect of the present invention relates to the apparatus for detecting unevenness of the surface (S), the apparatus comprising the sensor module according to this invention which is assembled to a driving tool (5) for driving the sensor module along the surface (S) to be detected.

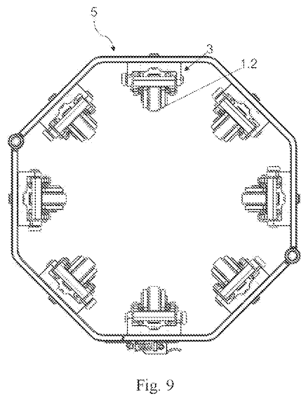

FIG. 8 shows the apparatus for detecting unevenness of the surface (S) which is equipped with the sensor module according to the first exemplary embodiment of the present invention while FIG. 9 shows the apparatus which is equipped with the sensor module according to the second exemplary embodiment of the present invention.

In an embodiment which is specifically adapted to use for detecting the unevenness of an external surface of a pipe, especially bulging and bowing of the pipe external surface, the apparatus comprises a plurality of sensor modules which are arranged around a circumference of the external surface of the pipe. Preferably, the sensor modules are arranged in pairs in a manner that each sensor module is arranged opposite each other. The arrangement of the sensor modules in pairs can provide the information about the diameters of the pipe. Further, the unevenness of the pipe can be determined using changing of the data regarding pipe diameters obtained from the detecting apparatus.

More preferably, at least four pairs of the sensor modules are arranged around the circumference of the external surface of the pipe in order to obtain a round profiles of pipe.

In addition, the apparatus according to the present invention may further comprise an auxiliary sensor for sensing additional data of the detected equipment. Examples of the auxiliary sensors are a carburization sensor and a crack and thickness measurement sensor.

The third aspect of the present invention relates to the method for detecting unevenness of a surface (S), the method comprising steps of:
a) inspecting the surface (S) by using the sensor module according to this invention to obtain data of changes in the magnetic lines of force;
b) sending data obtained from a) to the processor; and
c) converting data received from b) to distance changed from an initial position to a detected position to determining unevenness profiles of the surface (S).

The method of this invention may further comprise a step of amplifying the signal of data of changes in the magnetic lines of force before the step of converting data. In an embodiment, the step of amplifying the signal of data of changes in the magnetic lines of force is performed by using a gateway.

### BEST MODE OF THE INVENTION

Best mode of the invention is as described in the detailed description of the invention.

1. A sensor module for detecting unevenness of a surface (S), the sensor module comprising:
an arm assembly (1) comprising
an arm body (1.1) having at least two ends,
one or more surface contacting element (1.2) mounted to at least one end of the arm body (1.1);
a magnet assembly (2) comprising at least one magnet (2.1) to generate magnetic lines of force; and
a magnetic sensor assembly (3) comprising a magnetic sensor (3.1) being assembled adjacent to the magnet (2.1) for sensing changes in the magnetic lines of force in response to movement of the arm body (1.1).

2. The sensor module according to claim 1, wherein the arm assembly (1) further comprises a direction controlling means (1.3) for controlling a moving direction of the arm body (1.1) toward-backward the surface (S).

3. The sensor module according to claim 1, wherein the arm body (1.1) is shaped as a bar having an end (1.1.1) and a free end (1.1.2).

4. The sensor module according to claim 3, wherein the free end (1.1.2) is configured for mounting to the surface contacting element (1.2) which is biased into contact with the surface (S).

5. The sensor module according to claim 1, wherein the magnet assembly (2) is assembled to the arm assembly (1) in a manner that an arrangement of magnetic lines of force generated from the magnet (2.1) is correlated with the moving direction of the arm body (1.1).

6. The sensor module according to claim 2, wherein the direction controlling means (1.3) comprises a moving guide (1.3.1) assembled to the arm body (1.1), and a fixing guide (1.3.2) assembled to the arm body (1.1), wherein the moving guide (1.3.1) and the fixing guide (1.3.2) cooperate to guide the arm body (1.1) moves toward-backward the surface (S) in a direction perpendicular to the surface (S).

7. The sensor module according to claim 1, wherein the surface contacting element (1.2) is selected from one or more of wheel, roller, ball, track, and caterpillar.

8. The sensor module according to claim 1, wherein the arm assembly (1) further comprises a biasing assembly (1.4).

9. The sensor module according to claim 8, wherein the biasing assembly (1.4) comprises a surface contacting element support (1.4.1), an extended portion (1.4.2) extending downwardly from the surface contacting element support (1.4.1).

10. The sensor module according to claim 9, wherein the biasing assembly (1.4) further comprises an axis (1.4.3) extending from the extended portion (1.4.2) in a direction parallel to the arm body (1.1), a spring (1.4.4) provided on the axis (1.4.3) and an abut portion (1.4.5) provided at an end of the spring (1.4.4) for abutting the spring (1.4.4) in a compressed manner.

11. The sensor module according to claim 1, wherein the magnet (2.1) is selected from any one of magnet strip, magnet bar, round shaped magnet piece, semicircle shaped magnet piece, oval shaped magnet piece, square shaped magnet piece and triangle shaped magnet piece.

12. The sensor module according to claim 1, wherein the magnet (2.1) is a magnet strip provided on a surface of the arm body (1.1).

13. The sensor module according to claim 1, wherein the magnet (2.1) is a round shaped magnet piece provided in the magnet assembly (2).

14. The sensor module according to claim 1, wherein the sensor module further comprises a processor (4) being in communication with the magnetic sensor assembly (3) for receiving sensing data from the magnetic sensor (3.1) and converting to unevenness profiles of the surface (S).

15. The sensor module according to claim 14, wherein the magnetic sensor assembly (3) comprising:
the magnetic sensor (3.1);
a magnetic sensor holder (3.2) provided for holding the magnetic sensor (3.1) to be in proximity and face the magnet (2.1); and
a circuit (3.3) electrically connected to the magnet sensor (3.1) for receiving the sensed data from the magnetic sensor (3.1) and sending the sensed data to the processor (4).

16. The sensor module according to claim 1, wherein
the arm body (1.1) is rotatably assembled to the magnet assembly (2); and
the direction controlling means (1.3) comprising a rotating guide (1.3.3) and a fixing rod (1.3.4), the rotating guide (1.3.3) rotatably assembled to the end (1.1.1) of the arm body (1.1) and slidably assembled to the fixing rod (1.3.4) through a hole (1.3.3.1) provided on the rotating guide (1.3.3), and an end of the fixing rod (1.3.4) is assembled to the magnetic sensor assembly (3).

17. The sensor module according to claim 1, wherein the surface contacting element (1.2) is biased into contact with the surface (S) by means of a torsion spring provided between the arm body (1.1) and the magnetic sensor assembly (3).

18. The sensor module according to claim 1, wherein the magnet assembly (2) comprising:
the magnet (2.1); and
a rod (2.2) having an end (2.2.1) rotatably assembled to the arm body (1.1) and another end (2.2.2) rotatably assembled to the magnetic sensor assembly (3),
wherein the magnet (2.1) is a magnet rotary which is provided at a position where the rod (2.2) is assembled to the magnetic sensor assembly (3).

19. The sensor module according to claim 15, wherein the magnetic sensor assembly (3) comprises a magnetic sensor frame (3.4) to which the magnetic sensor (3.1) is attached, and the circuit (3.3) mounted to the magnetic sensor frame (3.4) and electrically connected to the magnet sensor (3.1) for receiving the sensed data from the magnetic sensor (3.1) and sending the sensed data to the processor (4).

20. The sensor module according to claim 19, wherein the magnetic sensor frame (3.4) is in L-inverted shape having an end (3.4.1) rotatably assembled to the magnet assembly (2) and another end (3.4.2) assembled to the fixing rod (1.3.4) of the direction controlling means (1.3).

21. The sensor module according to claim 19, wherein the magnetic sensor (3.1) is attached on the magnetic sensor frame (3.4) at a position proximity to the magnet (2.1).

22. An apparatus for detecting unevenness of a surface (S), the apparatus comprising the sensor module according to claim 1 which is assembled to a driving tool for driving the sensor module along the surface (S) to be detected.

23. The apparatus according to claim 22 which is used for detecting unevenness of a pipe, wherein the apparatus comprising a plurality of sensor modules which are arranged around a circumference of an external surface of the pipe.

24. The apparatus according to claim 23, wherein the sensor modules are arranged in pairs in a manner that each sensor module is arranged opposite each other.

25. The apparatus according to claim 24, wherein at least four pairs of the sensor modules are arranged around the circumference of the external surface of the pipe.

26. The apparatus according to claim 22 further comprising an auxiliary sensor which is a carburization sensor, crack and thickness measurement sensor.

27. A method for detecting unevenness of a surface (S), the method comprising steps of:
a) inspecting the surface (S) by using the sensor module according to claim 1 to obtain data of changes in the magnetic lines of force;
b) sending data obtained from a) to the processor; and
c) converting data received from b) to distance changed from an initial position to a detected position to determining unevenness profiles of the surface (S).

28. The method according to claim 27 further comprises a step of amplifying the signal of data of changes in the magnetic lines of force before the step of converting data.

29. The method according to claim 28 wherein the step of amplifying the signal of data of changes in the magnetic lines of force is performed by using a gateway.

30. A method of detecting unevenness of a surface, comprising
providing a sensor module according to claim 1; and
contacting the one or more surface contacting element of the sensor module to the surface.
